(19) United States
(12) Patent Application Publication
(10) Pub. No.: US 2021/0400957 A1
(43) Pub. Date: Dec. 30, 2021

(54) AUXIN HERBICIDE AND L-GLUFOSINATE MIXTURES

(71) Applicant: Monsanto Technology LLC, St. Louis, MO (US)

(72) Inventor: John W. HEMMINGHAUS, Chesterfield, MO (US)

(21) Appl. No.: 17/359,137

(22) Filed: Jun. 25, 2021

Related U.S. Application Data
(60) Provisional application No. 63/045,410, filed on Jun. 29, 2020.

(51) Int. Cl. A01N 25/30; A01N 37/40; A01N 57/20

(52) U.S. Cl. CPC A01N 25/30; A01N 57/20; A01N 37/40

(57) ABSTRACT

The present disclosure generally relates to aqueous herbicidal compositions comprising a glufosinate component comprising L-glufosinate and/or a salt thereof and an auxin herbicide component. The present disclosure further relates to methods of preparing these compositions and methods of controlling unwanted plants using these compositions. The present disclosure is also directed to methods of reducing the volatility and/or driftable spray fines of a tank mixture comprising an auxin herbicide component.

### CROSS-REFERENCE TO RELATED APPLICATION

This application claims the benefit of, and priority to, U.S. patent application Ser. No. 63/045,410 filed Jun. 29, 2020. The entire disclosure of the above application is incorporated herein by reference.

### FIELD

The present disclosure generally relates to aqueous herbicidal compositions comprising a glufosinate component comprising L-glufosinate and/or a salt thereof and an auxin herbicide component. The present disclosure further relates to methods of preparing these compositions and methods of controlling unwanted plants using these compositions. The present disclosure is also directed to methods of reducing the volatility and/or driftable spray fines of a tank mixture comprising an auxin herbicide component.

### BACKGROUND

This section provides background information related to the present disclosure which is not necessarily prior art.

To enhance the efficiency of applying herbicidal active ingredients, it is highly desirable to combine two or more active ingredients in a single formulation. Applying a combination of active ingredients with different modes of action can also provide for greater weed control and address weed resistance. Also, new trait technologies in corn, soybean, cotton, and other plants enable application of herbicides, which in the past have not been possible. Glufosinate is known to be useful as an effective broad spectrum, non-selective post-emergence herbicide. Glufosinate is a contact herbicide and its primary mode of action is inhibition of glutamine synthetase. Typically, glufosinate is formulated as a salt, particularly the ammonium salt. One or more surfactants are also typically included in glufosinate formulations to enhance the efficacy of the herbicide.

Auxin herbicides are one class of herbicides that can supplement of the action of primary post-emergence herbicides like glufosinate. Auxin herbicides mimic or act like natural auxin plant growth regulators. Auxin herbicides appear to affect cell wall plasticity and nucleic acid metabolism, which can lead to uncontrolled cell division and growth. The injury symptoms caused by auxin herbicides include epinastic bending and twisting of stems and petioles, leaf cupping and curling, and abnormal leaf shape and venation.

Off-site movement is sometimes associated with certain auxin herbicide formulations, and tank mixing with certain other herbicides has been found to affect off-site movement of the auxin herbicide. Accordingly, there remains a need for herbicide mixtures containing glufosinate and one or more auxin herbicides that exhibit reduced auxin herbicide off-site movement upon application.

### SUMMARY

This section provides a general summary of the disclosure, and is not a comprehensive disclosure of its full scope or all of its features.

Various aspects of the present disclosure relate to aqueous herbicidal compositions comprising: a glufosinate component comprising L-glufosinate and/or a salt thereof, wherein the L-glufosinate and/or salt thereof constitutes about 90 wt. % or more, about 95 wt. % or more, about 99 wt. % or more, or about 99.9 wt. % or more of the glufosinate component; an auxin herbicide component; and water, wherein the molar ratio of the auxin herbicide component to the glufosinate component on an acid equivalent basis is about 1:1, about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, or about 2:1 or greater, and wherein the total herbicide concentration of the composition on an acid equivalent basis is about 5 wt. % or less, about 4 wt. % or less, about 3 wt. % or less, about 2 wt. % or less, about 1 wt. % or less, or about 0.5 wt. % or less.

In other aspects, the present disclosure relates to methods of controlling the growth of unwanted plants. Various methods comprise applying to the unwanted plants an herbicidally effective amount of a tank mixture comprising a herbicidal composition as described herein. Other methods comprise mixing a first aqueous composition comprising a glufosinate component comprising L-glufosinate and/or a salt thereof with a second aqueous composition comprising an auxin herbicide component to form a tank mixture, wherein the L-glufosinate and/or salt thereof constitutes about 90 wt. % or more, about 95 wt. % or more, about 99 wt. % or more, or about 99.9 wt. % or more of the glufosinate component in the first aqueous composition; and applying the tank mixture to the unwanted plants, wherein the application rate of the glufosinate component is about 480 g/ha or less about, 400 g/ha or less, about 300 g/ha or less, or about 280 g/ha or less and the application rate of the auxin herbicide component is about 300 g/ha or more, about 400 g/ha or more, about 450 g/ha or more, or about 480 g/ha or more.

Still further aspects of the present disclosure relate to methods of reducing auxin herbicide off-target movement upon application of a tank mixture to unwanted plants. Various methods comprise preparing a first aqueous composition comprising a glufosinate component comprising L-glufosinate and/or a salt thereof, wherein the L-glufosinate and/or salt thereof constitutes about 90 wt. % or more, about 95 wt. % or more, about 99 wt. % or more, or about 99.9 wt. % or more of the glufosinate component; preparing a second aqueous composition comprising an auxin herbicide component; mixing the first aqueous composition and second aqueous composition to form a tank mixture; and applying the tank mixture to the unwanted plants, wherein the application rate of the glufosinate component is about 480 g/ha or less about, 400 g/ha or less, about 300 g/ha or less, or about 280 g/ha or less and the application rate of the auxin herbicide component is about 300 g/ha or more, about 400 g/ha or more, about 450 g/ha or more, or about 480 g/ha or more, and wherein the auxin herbicide off-target movement upon application is reduced as compared to a similar tank mixture containing D,L-glufosinate.

Other aspects of the present disclosure relate to methods of reducing the volatility of a tank mixture comprising an auxin herbicide component. Various methods comprise mixing a first aqueous composition comprising a glufosinate component comprising L-glufosinate and/or a salt thereof with a second aqueous composition comprising an auxin herbicide component to form the tank mixture, wherein the L-glufosinate and/or salt thereof constitutes about 90 wt. % or more, about 95 wt. % or more, about 99 wt. % or more, or about 99.9 wt. % or more of the glufosinate component in the first aqueous composition, wherein the tank mixture exhibits a reduced auxin herbicide volatility as compared to a similar tank mixture containing D,L-glufosinate.

Further aspects of the present disclosure relate to methods of reducing driftable spray fines of a tank mixture comprising an auxin herbicide component. Various methods comprise mixing a first aqueous composition comprising a glufosinate component comprising L-glufosinate and/or a salt thereof with a second aqueous composition comprising an auxin herbicide component to form the tank mixture, wherein the L-glufosinate and/or salt thereof constitutes about 90 wt. % or more, about 95 wt. % or more, about 99 wt. % or more, or about 99.9 wt. % or more of the glufosinate component in the first aqueous composition, wherein the tank mixture upon spray application exhibits a spray particle size distribution having a reduced amount of particles that are less than 150 microns as compared to a similar tank mixture containing D,L-glufosinate.

Other objects and features will be in part apparent and in part pointed out hereinafter. The description and specific examples in this summary are intended for purposes of illustration only and are not intended to limit the scope of the present disclosure.

### DETAILED DESCRIPTION

Example embodiments will now be described more fully. The description and specific examples included herein are intended for purposes of illustration only and are not intended to limit the scope of the present disclosure.

Generally, the present disclosure relates to aqueous herbicidal compositions comprising a glufosinate component comprising L-glufosinate and an auxin herbicide component. The present disclosure also relates to methods for controlling the growth of unwanted plants comprising applying an herbicidally effective amount of a tank mixture to the unwanted plants. The present disclosure further relates to methods of reducing auxin herbicide off-target movement (e.g., auxin herbicide volatility and/or driftable spray fines) upon application of a tank mixture to unwanted plants.

As noted, auxin herbicides such as 2,4-D and dicamba are highly effective on broadleaf weeds. Glufosinate is a non-selective herbicide that is highly effective on broadleaf weeds and some grass species. Application of these herbicides together would enable a grower to utilize two effective modes of action in one pass, improve the durability profile of these products, and provide better weed control. However, compatibility challenges between glufosinate and the auxin herbicides can lead to higher levels of auxin herbicide off-target movement.

Glufosinate (phosphinothricin) has two stereoisomers (D- and L-enantiomers) and is generally produced and supplied as a 50/50 racemic mixture of the D- and L-enantiomers (i.e., D,L-glufosinate). However, new processes have been developed to produce substantially pure L-glufosinate. For example, see U.S. Pat. No. 10,260,078, which is incorporated herein by reference. Also, it has been found that L-glufosinate is as effective as formulations of the racemic mixture even when used at one-half (1/2) the application rate. Using formulations at one-half (1/2) the labeled rate can improve compatibility by delivering lower levels of salt-forming ions such as ammonium and surfactant(s) in the spray tank, which in turn, can also reduce the potential for off-site movement of the auxin herbicide(s) upon application. Accordingly, various herbicidal compositions of the present disclosure comprise a glufosinate component comprising L-glufosinate and/or a salt thereof, wherein the L-glufosinate and/or salt thereof constitutes about 90 wt. % or more, about 95 wt. % or more, about 99 wt. % or more, or about 99.9 wt. % or more of the glufosinate component; an auxin herbicide component; and water

In various embodiments, the molar ratio of the auxin herbicide component to the glufosinate component on an acid equivalent basis is about 1:1, about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, or about 2:1 or greater. For example, the molar ratio of the auxin herbicide component to the glufosinate component on an acid equivalent basis can be from about 1:1 to about 4:1, from about 1:1 to about 3:1, from about 1:1 to about 2:1, from about 1:1 to about 1.5:1, from about 1.1:1 to about 4:1, from about 1.1:1 to about 3:1, from about 1.1:1 to about 2:1, from about 1.1:1 to about 1.5:1, from about 1.4:1 to about 4:1, from about 1.4:1 to about 3:1, from about 1.4:1 to about 2:1, or from about 1.4:1 to about 1.5:1.

In some embodiments, the herbicidal composition is a tank mixture (e.g., an application mixture). For example, the total herbicide concentration of the composition (e.g., the glufosinate component and auxin herbicide component) on an acid equivalent basis can be about 5 wt. % or less, about 4 wt. % or less, about 3 wt. % or less, about 2 wt. % or less, about 1 wt. % or less, or about 0.5 wt. % or less. In further embodiments, the total herbicide concentration of the composition on an acid equivalence basis is from about 0.1 wt. % to about 5 wt. %, from about 0.1 wt. % to about 4 wt. %, from about 0.1 wt. % to about 3 wt. %, from about 0.1 wt. % to about 2 wt. %, from about 0.1 wt. % to about 1 wt. %, from about 0.25 wt. % to about 5 wt. %, from about 0.25 wt. % to about 4 wt. %, from about 0.25 wt. % to about 3 wt. %, from about 0.25 wt. % to about 2 wt. %, from about 0.25 wt. % to about 1 wt. %, from about 0.5 wt. % to about 5 wt. %, from about 0.5 wt. % to about 4 wt. %, from about 0.5 wt. % to about 3 wt. %, from about 0.5 wt. % to about 2 wt. %, or from about 0.5 wt. % to about 1 wt. %.

Glufosinate Component

As noted, compositions of the present disclosure comprise a glufosinate component comprising L-glufosinate and/or a salt thereof, wherein the L-glufosinate and/or salt thereof constitutes about 90 wt. % or more, about 95 wt. % or more, about 99 wt. % or more, or about 99.9 wt. % or more of the glufosinate component. In various embodiments, the composition is free or essentially free (e.g., less than 1 wt. %, less than 0.1 wt. %, or even less than 0.01 wt. %) of D-glufosinate and salts thereof.

The glufosinate component can include the acid form of glufosinate as well as various salts and/or esters thereof. Glufosinate salts generally include ammonium, alkali metal (e.g., potassium or sodium), and organic ammonium salts. The ammonium salt of glufosinate is a common commercially available form. Thus, in various embodiments, the glufosinate component comprises the ammonium salt of L-glufosinate.

Various herbicidal compositions described herein provide for a reduced loading of the glufosinate component while achieving approximately equivalent weed control. For example, in various embodiments, the concentration of the glufosinate component on an acid equivalence basis is about 2 wt. % or less, about 1 wt. % or less, about 0.75 wt. % or less, about 0.5 wt. % or less, about 0.25 wt. % or less, or about 0.1 wt. % or less. In some embodiments, the concentration of the glufosinate component on an acid equivalence basis is from about 0.1 wt. % to about 2 wt. %, from about 0.1 wt. % to about 1 wt. %, from about 0.1 wt. % to about 0.75 wt. %, from about 0.1 wt. % to about 0.5 wt. %, from about 0.1 wt. % to about 0.25 wt. %, from about 0.2 wt. % to about 2 wt. %, from about 0.2 wt. % to about 1 wt. %, from about 0.2 wt. % to about 0.75 wt. %, from about 0.2 wt. % to about 0.5 wt. %, or from about 0.2 wt. % to about 0.25 wt. %.

Auxin Herbicide Component

Compositions of the present disclosure also comprise an auxin herbicide component. Examples of auxin herbicides include benzoic acid herbicides, phenoxy herbicides, pyridine carboxylic acid herbicides, pyridine oxy herbicides, pyrimidine carboxy herbicides, quinoline carboxylic acid herbicides, and benzothiazole herbicides. Specific examples of auxin herbicides include dicamba (3,6-dichloro-2-methoxy benzoic acid); 2,4-D (2,4-dichlorophenoxyacetic acid); 2,4-DB (4-(2,4-dichlorophenoxy)butanoic acid); dichloroprop (2-(2,4-dichlorophenoxy)propanoic acid); MCPA ((4-chloro-2-methylphenoxy)acetic acid); MCPB (4-(4-chloro-2-methylphenoxy)butanoic acid); aminopyralid (4-amino-3,6-dichloro-2-pyridinecarboxylic acid); fluoroxpyr ([(4-amino-3,5-dichloro-6-fluoro-2-pyridinyl)oxy]acetic acid); triclopyr ([(3,5,6-trichloro-2-pyridinyl)oxy]acetic acid); diclopyr; mecoprop ((2-(4-chloro-2-methylphenoxy)propanoic acid); mecoprop-P; picloram (4-amino-3,5,6-trichloro-2-pyridinecarboxylic acid); quinclorac (3,7-dichloro-8-quinolinecarboxylic acid); aminocyclopyrachlor (6-amino-5-chloro-2-cyclopropyl-4-pyrimidinecarboxylic acid); benazolin; halauxifen; fluorpyrauxifen; methyl 4-amino-3-chloro-5-fluoro-6-(7-fluoro-1H-indo1-6-yl)pyridine-2-carboxylate; 4-amino-3-chloro-5-fluoro-6-(7-fluoro-1H-indo1-6-yl)pyridine-2-carboxylic acid; benzyl 4-amino-3-chloro-5-fluoro-6-(7-fluoro-1H-indo1-6-yl)pyridine-2-carboxylate; methyl 4-amino-3-chloro-5-fluoro-6-(7-fluoro-l-isobutyryl-1H-indo1-6-yl)pyridine-2-carboxylate; methyl 4-amino-3-chloro-6-[1-(2,2-dimethylpropanoyl)-7-fluoro-1H-indo1-6-yl]-5-fluoropyridine-2-carboxylate; methyl 4-amino-3-chloro-5-fluoro-6-[7-fluoro-1-(methoxyacetyl)-1H-indo1-6-yl]pyridine-2-carboxylate; methyl 6-(1-acetyl-7-fluoro-1H-indo1-6-y1)-4-amino-3-chloro-5-fluoropyridine-2-carboxylate; potassium 4-amino-3-chloro-5-fluoro-6-(7-fluoro-1H-indo1-6-yl)pyridine-2-carboxylate; and butyl 4-amino-3-chloro-5-fluoro-6-(7-fluoro-1H-indo1-6-yl)pyridine-2-carboxylate; including salts and esters thereof, racemic mixtures and resolved isomers thereof; and combinations thereof.

In various embodiments, the auxin herbicide component comprises dicamba and/or a salt thereof. Examples of dicamba salts include the monoethanolamine, tetrabutylamine, dimethylamine (e.g., BANVEL, ORACLE, etc.), isopropylamine, diglycolamine (e.g., CLARITY, VANQUISH, etc.), potassium, and sodium salts, and combinations thereof. Commercially available sources of dicamba and its salts includes those products sold under the trade names XTENDIMAX, BANVEL, CLARITY, ENGENIA, DIABLO, DISTINCT, ORACLE, VANQUISH, and VISION.

Other agronomically acceptable salts of auxin herbicides include polyamine salts such as those described in U.S. Patent Application Publication No. 2012/0184434, which is incorporated herein by reference. The polyamines described in U.S. 2012/0184434 include those of formula (A):

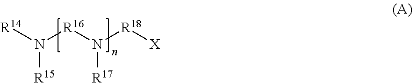

wherein R¹⁴, R¹⁵, R¹⁷, R¹⁹ and R²° are independently H or C₁-C₆-alkyl, which is optionally substituted with OH, R¹⁶ and R¹⁸ are independently C₂-C₄-alkylene, X is OH or NR¹⁹R²⁰, and n is from 1 to 20; and those of formula (B):

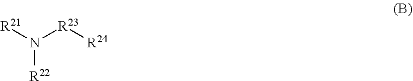

wherein R²¹ and R²² are independently H or C₁-C₆-alkyl, R²³ is C₁-C₁₂-alkylene, and R²⁴ is an aliphatic C₅-C₈ ring system, which comprises either nitrogen in the ring or which is substituted with at least one unit NR²¹R²² . Specific examples of these polyamines include tetraethylenepentamine, triethylenetetramine, diethylenetriamine, pentamethyldiethylenetriamine, N,N,N′,N″,N″-pentamethyl-dipropylenetriamine, N,N-bis(3-dimethylaminopropyl)-N-isopropanolamine, N′-(3-(dimethylamino)propyl)-N,N-dimethyl-1,3-propanediamine, N,N-bis(3-aminopropyl)methylamine, N-(3-dimethylaminopropyl)-N,N-diisopropanolamine, N,N,N′-trimethylaminoethyl-ethanolamine, aminopropylmonomethylethanolamine, and aminoethylethanolamine, and mixtures thereof.

In certain embodiments, the auxin herbicide component comprises at least one salt of dicamba selected from the group consisting of the monoethanolamine salt, tetrabutylamine salt, dimethylamine salt, isopropylamine salt, diglycolamine salt, N,N-bis-(3-aminopropyl)methylamine salt, potassium salt, sodium salt, and combinations thereof. In some embodiments, the auxin herbicide component comprises the monoethanolamine salt of dicamba. In various embodiments, the auxin herbicide component comprises the diglycolamine salt of dicamba. In further embodiments, the auxin herbicide component comprises the N,N-bis-(3-aminopropyl)methylamine salt of dicamba.

In various embodiments, the auxin herbicide component comprises 2,4-D and/or a salt thereof. Examples of 2,4-D salts include the choline, dimethylamine, and isopropylamine salts, and combinations thereof. Commercially available sources of 2,4-D and its salts include those products sold under trade names BARRAGE, FORMULA 40, OPT-AMINE, and WEEDAR 64.

In various embodiments, the concentration of the auxin herbicide component on an acid equivalence basis is at least about 0.1 wt. % or more, about 0.25 wt. % or more, about 0.5 wt. % or more, about 0.75 wt. % or more, about 1 wt. % or more, about 2 wt. % or more, about 3 wt. % or more, or about 4 wt. % or more. In some embodiments, the concentration of the auxin herbicide component on an acid equivalence basis is from about 0.1 wt. % to about 4.5 wt. %, from about 0.1 wt. % to about 4 wt. %, from about 0.1 wt. % to about 3 wt. %, from about 0.1 wt. % to about 2 wt. %, from about 0.1 wt. % to about 1 wt. %, from about 0.1 wt. % to about 0.5 wt. %, from about 0.4 wt. % to about 4.5 wt. %, from about 0.4 wt. % to about 4 wt. %, from about 0.4 wt. % to about 3 wt. %, from about 0.4 wt. % to about 2 wt. %, from about 0.4 wt. % to about 1 wt. %, or from about 0.4 wt. % to about 0.75 wt. %.

Monocarboxylic Acid and/or Salt Thereof

The herbicidal compositions described herein further comprise an additive to control or reduce potential herbicide volatility. Under some application conditions, certain auxin herbicides, can vaporize into the surrounding atmosphere and migrate from the application site to adjacent crop plants, such as soybean and cotton, where contact damage to sensitive plants can occur. For example, as described in U.S. Application Publication Nos. 2014/0128264 and 2015/0264924, which are incorporated herein by reference, additives to control or reduce potential herbicide volatility include monocarboxylic acids and/or salts thereof.

“Monocarboxylic acid” refers to a hydrocarbon or substituted hydrocarbon containing only one carboxy functional group (i.e., R¹—C(O)OH). The salt of a monocarboxylic acid (i.e., a monocarboxylate) refers to the general structure R¹—C(O)OM wherein M is an agriculturally acceptable cation. In various embodiments, the composition comprises at least one salt of a monocarboxylic acid, which in aqueous compositions may be present, in whole or in part, in dissociated form as a monocarboxylate anion and the corresponding cation.

Representative monocarboxylic acids and salts thereof generally comprise a hydrocarbon or unsubstituted hydrocarbon selected from, for example, unsubstituted or substituted, straight or branched chain alkyl (e.g., C₁-C₂₀ alkyl such as methyl, ethyl, n-propyl, isopropyl, etc.); unsubstituted or substituted, straight or branched chain alkenyl (e.g., C₂-C₂₀ alkyl such as ethenyl, n-propenyl, isopropenyl, etc.); unsubstituted or substituted aryl (e.g., phenyl, hydroxyphenyl, etc.); or unsubstituted or substituted arylalkyl (e.g., benzyl). In particular, the monocarboxylic acid can be selected from the group consisting of formic acid, acetic acid, propionic acid, and benzoic acid. The salt of the monocarboxylic acid can be selected from the group consisting of formate salts, acetate salts, propionate salts, and benzoate salts. The salt of the monocarboxylic acid can include, for example, alkali metal salts selected from sodium and potassium. Some preferred salts of the monocarboxylic acid include sodium acetate and potassium acetate.

In various embodiments, the concentration of the monocarboxylic acid and/or salt thereof is at least about 0.01 wt. % or more, about 0.02 wt. % or more, about 0.05 wt. % or more, about 0.1 wt. % or more, about 0.5 wt. % or more, or about 1 wt. % or more. For example, the concentration of the monocarboxylic acid and/or salt thereof is from about 0.01 wt. % to about 2 wt. %, from about 0.02 wt. % to about 2 wt. %, from about 0.05 wt. % to about 2 wt. %, from about 0.1 wt. % to about 2 wt. %, from about 0.5 wt. % to about 2 wt. %, from about 0.01 wt. % to about 1 wt. %, from about 0.02 wt. % to about 1 wt. %, from about 0.05 wt. % to about 1 wt. %, from about 0.1 wt. % to about 1 wt. %, or from about 0.5 wt. % to about 1 wt. %.

In some embodiments, the acid equivalent molar ratio of the monocarboxylic acid and/or salt thereof to the auxin herbicide component is at least about 1:10, at least about 1:5, at least about 1:3, at least about 1:2, at least about 1:1, at least about 2:1, at least about 3:1, at least about 4:1, at least about 5:1, at least about 6:1, at least about 8:1, or at least about 10:1. For example, the acid equivalent molar ratio of the monocarboxylic acid and/or salt thereof to the auxin herbicide component can be from about 10:1 to about 1:10, from about 10:1 to about 1:5, from about 5:1 to about 1:5, from about 3:1 to about 1:3, from about 2:1 to about 1:2, from about 1:1 to about 10:1, from about 1:1 to about 8:1, from about 1:1 to about 6:1, from about 1:1 to about 5:1, from about 1:1 to about 4:1, from about 1:1 to about 3:1, or from about 1:1 to about 2:1.

Surfactant Component

The compositions of the present disclosure can comprise a surfactant component. In various embodiments, the surfactant component comprises at least one surfactant selected from the group consisting of alkyl sulfates, alkyl ether sulfates, alkyl aryl ether sulfates, alkyl sulfonates, alkyl ether sulfonates, alkyl aryl ether sulfonates, alkylpolysaccharides, amidoalkylamines, alkoxylated alcohols, alkoxylated alkylamines, alkoxylated phosphate esters, and combinations thereof. For example, the surfactant component can comprise two or more surfactants.

As noted, by formulating with L-glufosinate and/or salts thereof, the amount surfactant required can be reduced. Accordingly, in various embodiments, the concentration of the surfactant component is about 0.2 wt. % or less, about 0.1 wt. % or less, about 0.05 wt. % or less, about 0.02 wt. % or less, about 0.01 wt. % or less, or about 0.005 wt. % or less. In some embodiments, the concentration of the surfactant component can be from about 0.001 wt. % to about 0.2 wt. %, from about 0.001 wt. % to about 0.1 wt. %, from about 0.001 wt. % to about 0.05 wt. %, from about 0.001 wt. % to about 0.01 wt. %, from about 0.01 wt. % to about 0.2 wt. %, from about 0.01 wt. % to about 0.1 wt. %, or from about 0.01 wt. % to about 0.05 wt. %.

Sulfate Surfactants

In various embodiments, the surfactant component comprises one or more alkyl sulfates, alkyl ether sulfates, and/or alkyl aryl ether sulfates. Examples of these surfactants include compounds of Formulas (1a), (1b), and (1c):

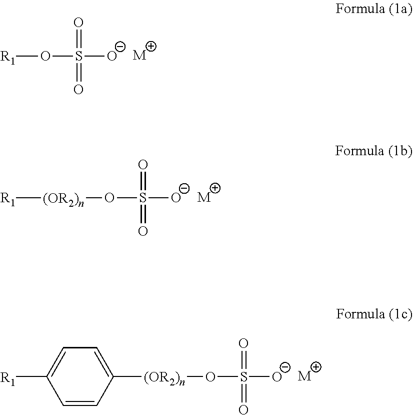

wherein compounds of Formula (la) are alkyl sulfates, compounds of Formula (1b) are alkyl ether sulfates, and compounds of Formula (1c) are alkyl aryl ether sulfates.

In Formulas (1a), (1b), and (1c), R₁ is a hydrocarbyl or substituted hydrocarbyl having from about 4 to about 22 carbon atoms, and M is selected from an alkali metal cation, ammonium, an ammonium compound, or H+. In Formulas (1b) and (1c), each R₂ in each of the (R₂O) groups is independently selected from C₁C₄ alkylene (e.g., n-propylene and/or ethylene), and n is from 1 to about 20. Examples of alkyl sulfates include sodium C₈₋₁₀ sulfate, sodium C₁₀₋₁₆ sulfate, sodium lauryl sulfate, sodium C₁₄₋₁₆ sulfate, diethanolamine lauryl sulfate, triethanolamine lauryl sulfate and ammonium lauryl sulfate. Examples of alkyl ether sulfates include sodium C₁₂₋₁₅ pareth sulfate (1 EO), ammonium C₆₋₁₀ alcohol ether sulfate, sodium C₆₋₁₀ alcohol ether sulfate, isopropylammonium C₆₋₁₀ alcohol ether sulfate, ammonium C₁₀₋₁₂ alcohol ether sulfate, and sodium lauryl ether sulfate. Examples of alkyl aryl ether sulfates include sodium nonylphenol ethoxylate sulfates. Specific examples of sulfate surfactants include AGNIQUE SLES-270 (C₁₀₋₁₆, 1-2.5 EO, sodium lauryl ether sulfate), WITCOLATE 1247H (C₆₋₁₀, 3E0, ammonium sulfate), WITCOLATE 7093 (C₆₋₁₀, 3EO, sodium sulfate), WITCOLATE 7259 (C₈₋₁₀ sodium sulfate), WITCOLATE 1276 (C₁₀₋₁₂, 5EO, ammonium sulfate), WITCOLATE LES-60A (C₁₂₋₁₄, 3EO, ammonium sulfate), WITCOLATE LES-60C (C₁₂₋₁₄, 3EO, sodium sulfate), WITCOLATE 1050 (C₁₂₋₁₅, 10EO, sodium sulfate), WITCOLATE WAQ (C₁₂₋₁₆ sodium sulfate), WITCOLATE D-51-51 (nonylphenol 4EO, sodium sulfate) and WITCOLATE D-51-53 (nonylphenol 10EO, sodium sulfate).

Alkylpolysaccharide Surfactants

In some embodiments, the surfactant component comprises one or more alkylpolysaccharide surfactants. Examples of alkylpolysaccharide surfactants include compounds of Formula (2):

R¹¹—O-(sug)ᵤ Formula (2)

wherein R¹¹ is a straight or branched chain substituted or unsubstituted hydrocarbyl selected from alkyl, alkenyl, alkylphenyl, alkenylphenyl having from about 4 to about 22 carbon atoms for from about 4 to 18 carbon atoms. The sug moiety is a saccharide residue, and may be an open or cyclic (i.e., pyranose) structure. The saccharide may be a monosaccharide having 5 or 6 carbon atoms, a disaccharide, an oligosaccharide or a polysaccharide. Examples of suitable saccharide moieties, including their corresponding pyranose form, include ribose, xylose, arabinose, glucose, galactose, mannose, telose, gulose, allose, altrose, idose, lyxose, ribulose, sorbose (sorbitan), fructose, and mixtures thereof. Examples of suitable disaccharides include maltose, lactose and sucrose. Disaccharides, oligosaccharides and polysaccharides can be a combination of two or more identical saccharides, for example maltose (two glucoses) or two or more different saccharides, for example sucrose (a combination of glucose and fructose). The degree of polymerization, u, is an average number from 1 to about 10, from 1 to about 8, from 1 to about 5, from 1 to about 3, and from 1 to about 2. In various embodiments, the alkylpolysaccharide surfactant may be an alkylpolyglucoside (APG) surfactant of formula (2) wherein: R¹¹ is a branched or straight chain alkyl group preferably having from 4 to 22 carbon atoms or from 8 to 18 carbon atoms, or a mixture of alkyl groups having an average value within the given range; sug is a glucose residue (e.g., a glucoside); and u is from 1 to about 5, and more preferably from 1 to about 3. In various embodiments, the surfactant component comprises an APG of formula (2) wherein R¹¹ is a branched or straight chain alkyl group having from 8 to 10 carbon atoms or a mixture of alkyl groups having an average value within the given range and u is from 1 to about 3.

Examples of alkylpolysaccharide surfactant are known in the art. Some preferred alkylpolysaccharide surfactants include AGNIQUE PG8107-G (AGRIMUL PG 2067) available from BASF and AL-2559 (C₉₋₁₁ alkylpolysaccharide) available from Croda. Representative surfactants are also presented in the table below wherein for each surfactant sug is a glucose residue.

Commercial Alkylpolysaccharide Surfactants

| Trade name | R¹¹ | u |
|---|---|---|
| APG 225 | C₈₋₁₂ alkyl | 1.7 |
| APG 325 | C₉₋₁₁ alkyl | 1.5 |
| APG 425 | C₈₋₁₆ alkyl | 1.6 |
| APG 625 | C₁₂₋₁₆ alkyl | 1.6 |
| GLUCOPON 600 | C₁₂₋₁₆ alkyl | 1.4 |
| PLANTAREN 600 | C₁₂₋₁₄ alkyl | 1.3 |
| PLANTAREN 1200 | C₁₂₋₁₆ alkyl | 1.4 |
| PLANTAREN 1300 | C₁₂₋₁₆ alkyl | 1.6 |
| PLANTAREN 2000 | C₈₋₁₆ alkyl | 1.4 |
| Agrimul PG 2076 | C₈₋₁₀ alkyl | 1.5 |
| Agrimul PG 2067 | C₈₋₁₀ alkyl | 1.7 |
| Agrimul PG 2072 | C₈₋₁₆ alkyl | 1.6 |
| Agrimul PG 2069 | C₉₋₁₁ alkyl | 1.6 |
| Agrimul PG 2062 | C₁₂₋₁₆ alkyl | 1.4 |
| Agrimul PG 2065 | C₁₂₋₁₆ alkyl | 1.6 |
| BEROL AG6202 | 2-ethyl-1-hexyl | |

Amidoalkylamine Surfactants

The surfactant component can comprise one or more amidoalkylamine surfactants. Examples of amidoalkylamine surfactants include compounds of Formula (3):

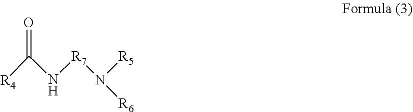

wherein R₄ is a hydrocarbyl or substituted hydrocarbyl having from 1 to about 22 carbon atoms, R₅ and R₆ are each independently hydrocarbyl or substituted hydrocarbyl having from 1 to about 6 carbon atoms and R₇ is hydrocarbylene or substituted hydrocarbylene having from 1 to about 6 carbon atoms.

R₄ is preferably an alkyl or substituted alkyl having an average value of carbon atoms between about 4 to about 20 carbon atoms, preferably an average value between about 4 and about 18 carbon atoms, more preferably an average value from about 4 to about 12 carbon atoms, more preferably an average value from about 5 to about 12 carbon atoms, even more preferably an average value from about 6 to about 12 carbon atoms, and still more preferably an average value from about 6 to about 10 carbon atoms. The R₄ alkyl group may be derived from a variety of sources that provide alkyl groups having from about 4 to about 18 carbon atoms, for example, the source may be butyric acid, valeric acid, caprylic acid, capric acid, coco (comprising mainly lauric acid), myristic acid (from, e.g., palm oil), soy (comprising mainly linoleic acid, oleic acid, and palmitic acid), or tallow (comprising mainly palmitic acid, oleic acid, and stearic acid). In some embodiments, the amidoalkylamine surfactant component may comprise a blend of amidoalkylamines having alkyl chains of various lengths from about 5 carbon atoms to about 12 carbon atoms. For example, depending upon the source of the R₄ alkyl group, an amidoalkylamine surfactant component may comprise a blend of surfactants having R₄ groups that are 5 carbon atoms in length, 6 carbon atoms in length, 7 carbon atoms in length, 8 carbon atoms in length, 9 carbon atoms in length, 10 carbon atoms in length, 11 carbon atoms in length, and 12 carbon atoms in length, longer carbon chains, and combinations thereof. In other embodiments, the amidoalkylamine surfactant component may comprise a blend of surfactants having R₄ groups that are 5 carbon atoms in length, 6 carbon atoms in length, 7 carbon atoms in length, and 8 carbon atoms in length. In some embodiments, the amidoalkylamine surfactant component may comprise a blend of surfactants having R₁ groups that are 6 carbon atoms in length, 7 carbon atoms in length, 8 carbon atoms in length, 9 carbon atoms in length, and 10 carbon atoms in length. In other embodiments, the amidoalkylamine surfactant component may comprise a blend of surfactants having R₄ groups that are 8 carbon atoms in length, 9 carbon atoms in length, 10 carbon atoms in length, 11 carbon atoms in length, and 12 carbon atoms in length.

R₅ and R₆ are independently preferably an alkyl or substituted alkyl having from 1 to about 4 carbon atoms. R₅ and R₆ are most preferably independently an alkyl having from 1 to about 4 carbon atoms, and most preferably methyl. R₇ is preferably an alkylene or substituted alkylene having from 1 to about 4 carbon atoms. R₇ is most preferably an alkylene having from 1 to about 4 carbon atoms, and most preferably n-propylene.

In various amidoalkylamine surfactants, R₄ is C₆₋₁₀, i.e., an alkyl group having 6 carbon atoms, 7 carbon atoms, 8 carbon atoms, 9 carbon atoms, 10 carbon atoms, or a blend of any of these, i.e., from about 6 carbon atoms to about 10 carbon atoms; R₅ and R₆ are each methyl; and R₇ is n-propylene (i.e., C₆₋₁₀ amidopropyl dimethylamine). One preferred amidoalkylamine surfactants is ADSEE C80W (coco amidopropyl dimethylamine), which is available from Akzo Nobel.

Alkoxylated Alcohol Surfactants

In some embodiments, the surfactant component comprises an alkoxylated alcohol surfactant. Examples of alkoxylated alcohol surfactants include compounds of Formula (4):

R₈—O—(R₉O)ₙH Formula (4)

wherein R₈ is a straight or branched chain hydrocarbyl having fan average of from about 4 to about 22 carbon atoms; each R₉ in each of the (R₉O) groups is independently selected from C₁-C₄ alkylene (e.g., n-propylene and/or ethylene); and n is an average value of from about 2 to about 50.

R₈ is preferably an alkyl group having from about 4 to about 22 carbon atoms, more preferably from about 8 to about 18 carbon atoms, and still more preferably from about 12 to about 18 carbons atoms. R₈ may be branched or straight. Preferably, R₈ is straight. The R₈ alkyl group may be derived from a variety of sources that provide alkyl groups having from about 4 to about 22 carbon atoms, for example, the source may be butyric acid, valeric acid, caprylic acid, capric acid, coco (comprising mainly lauric acid), myristic acid (from, e.g., palm oil), soy (comprising mainly linoleic acid, oleic acid, and palmitic acid), or tallow (comprising mainly palmitic acid, oleic acid, and stearic acid). Sources of the R₈ group include, for example, coco or tallow, or R₈ may be derived from synthetic hydrocarbyls, such as decyl, dodedecyl, tridecyl, tetradecyl, hexadecyl, or octadecyl groups. The R₈ alkyl chain in a population of alkoxylated alcohol co-surfactants typically comprises alkyl chains having varying length, for example, from 12 to 16 carbons in length, or from 16 to 18 carbons in length, on average. Most preferably, the R₈ alkyl chain comprises predominantly 12 to 16 carbon atoms. R₉ is preferably ethylene. The value of n is preferably an average between about 2 and about 30, more preferably between about 2 and about 20, even more preferably between about 2 and about 10.

Specific alkoxylated alcohol surfactants for use in the herbicidal compositions of the present disclosure include, for example, ETHYLANS, such as ETHYLAN 1005, ETHYLAN 1008, and ETHYLAN 6830 available from Akzo Nobel; BEROLS, such as BEROL 048, BEROL 050, BEROL 175, BEROL 185, BEROL 260, BEROL 266, and BEROL 84, among others, also available from Akzo Nobel; BRIJ 30, 35, 76, 78, 92, 97 or 98 available from ICI Surfactants; TERGITOL 15-S-3, 15-S-5, 15-S-7, 15-S-9, 15-S-12, 15-S-15 or 15-S-20 available from Union Carbide; SURFONIC L24-7, L12-8, L-5, L-9, LF-17 or LF-42 available from Huntsman, and SYNPERONIC 91/6 available from Croda.

Sulfonate Surfactants

In various embodiments, the surfactant component comprises one or more alkyl sulfonates, alkyl ether sulfonates, and/or alkyl aryl ether sulfonates. Examples of sulfonate surfactants include compounds of Formulas (5a), (5b), and (5c):

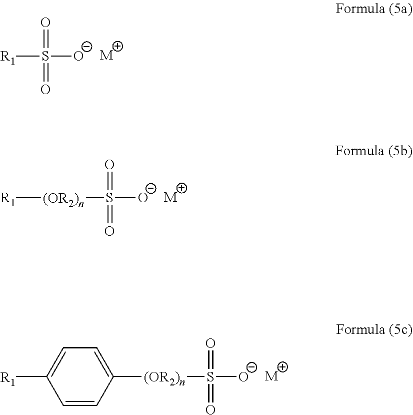

wherein compounds of Formula (5a) are alkyl sulfonates, compounds of Formula (5b) are alkyl ether sulfonates, and compounds of Formula (5c) are alkyl aryl ether sulfonates.

In Formulas (5a), (5b), and (5c), R₁ is a hydrocarbyl or substituted hydrocarbyl having from about 4 to about 22 carbon atoms, and M is selected from an alkali metal cation, ammonium, an ammonium compound, or H+. In Formulas (5b), and (5c), each R₂ in each of the (R20) groups is independently selected from C₁-C₄ alkylene (e.g., n-propylene and/or ethylene), and n is from 1 to about 20. Examples of sulfonate surfactants include, for example, WITCONATE 93S (isopropylamine of dodecylbenzene sulfonate), WITCONATE NAS-8 (octyl sulfonic acid, sodium salt), WITCONATE AOS (tetradecyl/hexadecyl sulfonic acid, sodium salt), WITCONATE 60T (linear dodecylbenzene sulfonic acid, triethanolamine salt) and WITCONATE 605a (branched dodecylbenzene sulfonic acid, N-butylamine salt).

Alkoxylated Alkylamine Surfactants

In some embodiments, the surfactant component comprises an alkoxylated alkylamine. Examples of alkoxylated alkylamine surfactants include compounds of Formula (6):

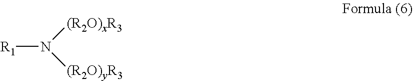

wherein R₁ is a straight or branched chain hydrocarbyl having an average of from about 5 to about 22 carbon atoms, preferably from about 12 to about 18 carbon atoms, more preferably a mixture of straight or branched chain hydrocarbyl groups having from about 14 to about 18 carbon atoms, still more preferably a mixture of straight or branched chain hydrocarbyl groups having from about 16 to about 18 carbon atoms (tallow), each R₂ in each of the (R₂O) groups is C₁-C₄ alkylene, more preferably C₂ alkylene, each R₃ is independently hydrogen or C₁-C₄ alkyl, preferably hydrogen, and, in some embodiments, x and y are average numbers such that the sum of x and y is from about 3 to about 30, more preferably from about 5 to about 20, more preferably from about 8 to about 20, more preferably from 8 to about 15, and still more preferably from about 9 to about 10. In other embodiments, x and y are average numbers such that the sum of x and y is greater than 5, such as in the range of from 6 to about 15, from 6 to about 12, or from 6 to about 10. Examples of suitable surfactants include, without restriction, BEROL 300 (cocoamine 5EO), BEROL 381 (tallowamine 15EO), BEROL 391 (tallowamine 5E0), BEROL 397 (cocoamine 15 EO), BEROL 398 (cocoamine 11 EO), BEROL 498 (tallowamine 10 EO), ETHOMEEN C/15 (cocoamine 5EO), ETHOMEEN C/25 (cocoamine 15 EO), ETHOMEEN T/15 (tallowamine 5EO), ETHOMEEN T/20 (tallowamine 10E0), ETHOMEEN T/19 (tallowamine 9EO), ETHOMEEN T/25 (tallowamine 15 EO), WITCAMINE TAM-105 (tallowamine 10 EO), WITCAMINE TAM-80 (tallowamine 8 EO), WITCAMINE TAM-60 (tallowamine 6EO), all available from Akzo Nobel.

Alkoxylated Phosphate Esters Surfactants

In various embodiments, the surfactant component comprises a phosphate ester of an alkoxylated tertiary amine. In some embodiments, the alkoxylated phosphate ester is selected from the group consisting of a phosphate ester of an alkoxylated tertiary amine, phosphate ester of an alkoxylated etheramine, phosphate ester of an alkoxylated alcohol, and a combination thereof. Examples of phosphate esters of alkoxylated tertiary amines include compounds of Formulas (7a) and (7b):

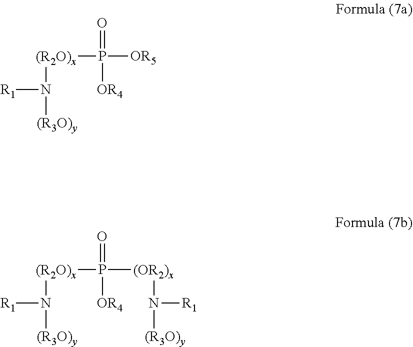

wherein each R₁ is independently a straight or branched chain hydrocarbyl having an average of from about 4 to about 22 carbon atoms, each R₂ in each of the (R₂O) groups and R₃ in each of the (R₃O) groups are each independently selected from C₁-C₄ alkylene, the sum of x and y are average numbers such that the sum of each x and y group is from about 2 to about 60, and R₄ and R₅ are each independently hydrogen or a straight or branched chain hydrocarbyl or substituted hydrocarbyl having from 1 to about 6 carbon atoms.

Each R₁ is preferably independently an alkyl having from about 4 to about 22 carbon atoms, more preferably from about 8 to about 18 carbon atoms, and still more preferably from about 12 to about 18 carbons atoms, for example coco or tallow. R₁ is most preferably tallow. Each R₂ and R₃ is preferably ethylene. The sum of each x and y group is preferably independently an average value ranging from about 2 to about 22, more preferably between about 10 and about 20, for example, about 15. More preferably R₄ and R₅ are each independently hydrogen or a linear or branched chain alkyl having from 1 to about 6 carbon atoms. R₄ and R₅ are preferably hydrogen.

Specific phosphate esters of alkoxylated tertiary amine surfactants for use in the herbicidal composition of the present disclosure are described in U.S. Application Publication

No. 2002/0160918, by Lewis et al. (Huntsman Petrochemical Corporation), such as phosphate esters of tallow amine ethoxylates, including phosphate esters of SURFONIC T5, phosphate esters of SURFONIC T15, phosphate esters of SURFONIC T20, and mixtures thereof, all available from Huntsman International LLC.

Examples of phosphate esters of alkoxylated etheramines include compounds of

Formulas (8a) and (8b):

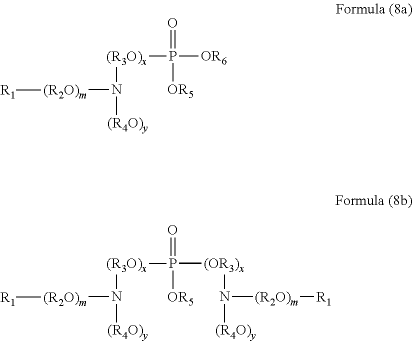

wherein each R₁ is independently a straight or branched chain hydrocarbyl having an average of from about 4 to about 22 carbon atoms; R₂ in each of the (R₂O) groups, R₃ in each of the (R₃O) groups, and R₄ in each of the (R₄O) groups are independently selected from C₁-C₄ alkylene; each m is independently an average number from about 1 to about 10; x and y are average numbers such that the sum of each x and y group is from about 2 to about 60; and each R₅ and R₆ are independently hydrogen or a straight or branched chain alkyl having from 1 to about 6 carbon atoms.

Each R₁ is preferably independently an alkyl having from about 4 to about 22 carbon atoms, more preferably from about 8 to about 18 carbon atoms, from about 10 to about 16 carbon atoms, from about 12 to about 18 carbons atoms, or from about 12 to about 14 carbon atoms. Sources of the R₁ group include, for example, coco or tallow, or R₁ may be derived from synthetic hydrocarbyls, such as decyl, dodedecyl, tridecyl, tetradecyl, hexadecyl, or octadecyl groups. Each R₂ may independently be propylene, isopropylene, or ethylene, and each m is preferably independently from about 1 to 5, such as 2 to 3. Each R₃ and R₄ may independently be ethylene, propylene, isopropylene, and are preferably ethylene. The sum of each x and y group is preferably independently an average value ranging from about 2 to about 22, such as from about 2 to 10, or about 2 to 5. In some embodiments, the sum of each x and y group is preferably independently between about 10 and about 20, for example, about 15. More preferably R₅ and R₆ are each independently hydrogen or a linear or branched chain alkyl having from 1 to about 6 carbon atoms. R₅ and R₆ are preferably hydrogen.

Examples of phosphate esters of alkoxylated alcohols include compounds of

Formulas (9a) and (9b):

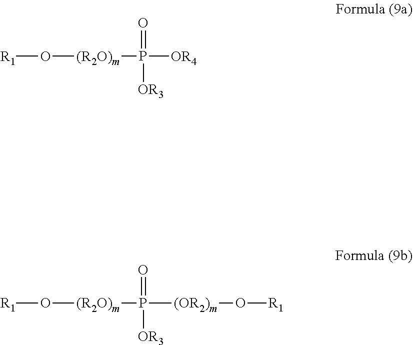

wherein each R₁ is independently a straight or branched chain hydrocarbyl having from about 4 to about 22 carbon atoms; R₂ in each of the (R₂O) groups is independently selected from C₁-C₄ alkylene; each m is independently an average number from about 1 to about 60; and R₃ and R₄ are each independently hydrogen or a straight or branched chain alkyl having from 1 to about 6 carbon atoms.

Each R₁ is preferably independently an alkyl having from about 4 to about 22 carbon atoms, more preferably from about 8 to about 20 carbon atoms, or an alkylphenyl having from about 4 to about 22 carbon atoms, more preferably from about 8 to about 20 carbon atoms. Sources of the R₁ group include, for example, coco or tallow, or R₁ may be derived from synthetic hydrocarbyls, such as decyl, dodedecyl, tridecyl, tetradecyl, hexadecyl, or octadecyl groups. Each R₂ may independently be propylene, isopropylene, or ethylene, and is preferably ethylene. Each m is preferably independently from about 9 to about 15. More preferably R₃ and R₄ are each independently hydrogen or a linear or branched chain alkyl having from 1 to about 6 carbon atoms. R₄ and R₅ are preferably hydrogen.

Specific phosphate esters of alkoxylated alcohol surfactants for use in the herbicidal composition of the present disclosure include, for example, EMPHOS CS-121, EMPHOS PS-400, and WITCONATE D-51-29, available from Akzo Nobel.

Additional Herbicide Ingredients

The herbicidal compositions of the present disclosure can further comprise an additional herbicide (i.e., in addition to the glufosinate component and auxin herbicide component). Additional herbicides include acetyl CoA carboxylase (ACCase) inhibitors, enolpyruvyl shikimate-3-phosphate synthase (EPSPS) inhibitors, photosystem I (PS I) inhibitors, photosystem II (PS II) inhibitors, acetolactate synthase (ALS) or acetohydroxy acid synthase (AHAS) inhibitors, mitosis inhibitors, protoporphyrinogen oxidase (PPO) inhibitors, hydroxyphenylpyruvate dioxygenase (HPPD) inhibitors, cellulose inhibitors, oxidative phosphorylation uncouplers, dihydropteroate synthase inhibitors, fatty acid and lipid biosynthesis inhibitors, auxin transport inhibitors, salts and esters thereof, racemic mixtures and resolved isomers thereof, and mixtures thereof. Examples of herbicides within these classes are provided below. Where an herbicide is referenced generically herein by name, unless otherwise restricted, that herbicide includes all commercially available forms known in the art such as salts, esters, free acids and free bases, as well as stereoisomers thereof. For example, where the herbicide name “glyphosate” is used, glyphosate acid, salts and esters are within the scope thereof.

In various embodiments, the additional herbicide comprises an EPSPS herbicide such as glyphosate or a salt or ester thereof.

In still further embodiments, the additional herbicide comprises a PPO inhibitor. PPO inhibitors include, for example, acifluorfen, azafenidin, bifenox, butafenacil, carfentrazone-ethyl, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil and sulfentrazone, salts and esters thereof, and mixtures thereof. In particular embodiments, the additional herbicide comprises fomesafen and/or a salt of fomesafen such as sodium fomesafen.

In various embodiments, the additional herbicide comprises a HPPD inhibitor. HPPD inhibitors include, for example, aclonifen, amitrole, beflubutamid, benzofenap, clomazone, diflufenican, fluridone, flurochloridone, flurtamone, isoxachlortole, isoxaflutole, mesotrione, norflurazon, picolinafen, pyrazolynate, pyrazoxyfen, sulcotrione, tembotrione and topramezone, salts and esters thereof, and mixtures thereof.

In some embodiments, the additional herbicide comprises a PS II inhibitor. PS II inhibitors include, for example, ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, salts and esters thereof, and mixtures thereof.

In certain embodiments, the additional herbicide comprises an ACCase inhibitor. ACCase inhibitors include, for example, alloxydim, butroxydim, clethodim, cycloxydim, pinoxaden, sethoxydim, tepraloxydim and tralkoxydim, salts and esters thereof, and mixtures thereof. Another group of ACCase inhibitors include chlorazifop, clodinafop, clofop, cyhalofop, diclofop, diclofop-methyl, fenoxaprop, fenthiaprop, fluazifop, haloxyfop, isoxapyrifop, metamifop, propaquizafop, quizalofop and trifop, salts and esters thereof, and mixtures thereof. ACCase inhibitors also include mixtures of one or more “dims” and one or more “fops”, salts and esters thereof.

In various embodiments, the additional herbicide comprises an ALS or AHAS inhibitor. ALS and AHAS inhibitors include, for example, amidosulfuron, azimsulfruon, bensulfuron-methyl, bispyribac-sodium, chlorimuron-ethyl, chlorsulfuron, cinosulfuron, cloransulam-methyl, cyclosulfamuron, diclosulam, ethametsulfuron-methyl, ethoxysulfuron, flazasulfuron, florazulam, flucarbazone, flucetosulfuron, flumetsulam, flupyrsulfuron-methyl, foramsulfuron, halosulfuron-methyl, imazamethabenz, imazamox, imazapic, imazapyr, imazaquin, imazethapyr, imazosulfuron, iodosulfuron, metsulfuron-methyl, nicosulfuron, penoxsulam, primisulfuron-methyl, propoxycarbazone-sodium, prosulfuron, pyrazosulfuron-ethyl, pyribenzoxim, pyrithiobac, rimsulfuron, sulfometuron-methyl, sulfosulfuron, thiencarbazone, thifensulfuron-methyl, triasulfuron, tribenuron-methyl, trifloxysulfuron and triflusulfuron-methyl, salts and esters thereof, and mixtures thereof.

In further embodiments, the additional herbicide comprises a mitosis inhibitor. Mitosis inhibitors include anilofos, benefin, DCPA, dithiopyr, ethalfluralin, flufenacet, mefenacet, oryzalin, pendimethalin, thiazopyr and trifluralin, salts and esters thereof, and mixtures thereof.

In some embodiments, the additional herbicide comprises a PS I inhibitor such as diquat and paraquat, salts and esters thereof, and mixtures thereof.

In certain embodiments, the additional herbicide comprises a cellulose inhibitor such as dichlobenil and isoxaben.

In still further embodiments, the additional herbicide comprises an oxidative phosphorylation uncoupler such as dinoterb, and esters thereof.

In other embodiments, the additional herbicide comprises an auxin transport inhibitor such as diflufenzopyr and naptalam, salts and esters thereof, and mixtures thereof.

In various embodiments, the additional herbicide comprises a dihydropteroate synthase inhibitor such as asulam and salts thereof.

In some embodiments, the additional herbicide comprises a fatty acid and lipid biosynthesis inhibitor such as bensulide, butylate, cycloate, EPTC, esprocarb, molinate, pebulate, prosulfocarb, thiobencarb, triallate and vernolate, salts and esters thereof, and mixtures thereof.

Other Additives

The herbicidal compositions described herein can further include other additives. Other useful additives include, for example, biocides or preservatives (e.g., PROXEL, commercially available from Avecia), antifreeze agents (such as glycerol, sorbitol, or urea), antifoam agents (such as Antifoam SE23 from Wacker Silicones Corp.), drift control agents, pH buffers, and bases.

Drift control agents suitable for the compositions and methods of the present disclosure are known to those skilled in the art and include GARDIAN, GARDIAN PLUS, DRI-GARD, and PRO-ONE XL, available from Van Diest Supply Co.; COMPADRE, available from Loveland Products, Inc.; BRONC MAX EDT, BRONC PLUS DRY EDT, EDT CONCENTRATE, and IN-PLACE, available from Wilbur-Ellis Company; STRIKE ZONE DF, available from Helena Chemical Co.; INTACT and INTACT XTRA, available from Precision Laboratories, LLC; and AGRHO DR 2000 and AGRHO DEP 775, available from the Solvay Group. Suitable drift control agents include, for example, guar-based (e.g., containing guar gum or derivatized guar gum) drift control agents. Various drift control products may also contain one or more conditioning agents in combination with the drift control agent(s).

The herbicidal compositions can further comprise an alkali metal phosphate such as dipotassium phosphate. Dipotassium phosphate, for example, can provide buffering and/or water-conditioning for the aqueous herbicidal compositions. Dipotassium phosphate is particularly effective as a replacement for ammonium sulfate in herbicidal compositions prepared using hard water. Similarly, the herbicidal compositions can further comprise an alkali metal carbonate, such as potassium carbonate, to provide additional buffering and/or water-conditiioning for aqueous herbicidal compositions of the present disclosure. In some embodiments, the herbicidal compositions comprise an alkali metal phosphate. In other embodiments, the herbicidal compositions comprise an alkali metal carbonate. In still other embodiments, the herbicidal compositions comprise an alkali metal phosphate and an alkali metal carbonate.

When the herbicidal composition comprises an alkali metal phosphate, such as dipotassium phosphate, the molar ratio of the alkali metal phosphate to the monocarboxylic acid and/or salt thereof, can range, for example, from about 1:5 to about 5:1, from about 3:1 to about 1:3, or from about 2:1 to about 1:2. In some embodiments, the molar ratio of alkali metal phosphate to monocarboxylic acid and/or salt thereof, is about 1:1.

When the herbicidal composition comprises an alkali metal carbonate, such as potassium carbonate, the molar ratio of the alkali metal carbonate to the monocarboxylic acid and/or salt thereof, can range, for example, from about 1:5 to about 5:1, from about 3:1 to about 1:3, or from about 2:1 to about 1:2. In some embodiments, the molar ratio of alkali metal carbonate to monocarboxylic acid and/or salt thereof, is about 1:1.

Methods of Use

As noted, other aspects of the present disclosure are directed to methods of controlling the growth of unwanted plants. In various embodiments, methods comprise applying to the unwanted plants an herbicidally effective amount of a tank mixture (e.g., an application mixture) comprising a herbicidal composition as described herein. Other methods comprise mixing a first aqueous composition comprising a glufosinate component comprising L-glufosinate and/or a salt thereof with a second aqueous composition comprising an auxin herbicide component to form a tank mixture, wherein the L-glufosinate and/or salt thereof constitutes about 90 wt. % or more, about 95 wt. % or more, about 99 wt. % or more, or about 99.9 wt. % or more of the glufosinate component in the first aqueous composition; and applying the tank mixture to the unwanted plants.

Still further aspects of the present disclosure relate to methods of reducing auxin herbicide off-target movement upon application of tank mixture (e.g., an application mixture) to unwanted plants. Various methods comprise preparing a first aqueous composition comprising a glufosinate component comprising L-glufosinate and/or a salt thereof, wherein the L-glufosinate and/or salt thereof constitutes about 90 wt. % or more, about 95 wt. % or more, about 99 wt. % or more, or about 99.9 wt. % or more of the glufosinate component; preparing a second aqueous composition comprising an auxin herbicide component; mixing the first aqueous composition and second aqueous composition to form a tank mixture; and applying the tank mixture to the unwanted plants, wherein the auxin herbicide off-target movement upon application is reduced as compared to a similar tank mixture except containing a glufosinate component comprising further comprising an equimolar amount of D-glufosinate to L-glufosinate.

Other aspects of the present disclosure relate to methods of reducing the volatility of a tank mixture comprising an auxin herbicide component. Various methods comprise mixing a first aqueous composition comprising a glufosinate component comprising L-glufosinate and/or a salt thereof with a second aqueous composition comprising an auxin herbicide component to form the tank mixture, wherein the L-glufosinate and/or salt thereof constitutes about 90 wt. % or more, about 95 wt. % or more, about 99 wt. % or more, or about 99.9 wt. % or more of the glufosinate component in the first aqueous composition, wherein the tank mixture exhibits a reduced auxin herbicide volatility as compared to a similar tank mixture containing D,L-glufosinate.

Further aspects of the present disclosure relate to methods of reducing driftable spray fines of a tank mixture comprising an auxin herbicide component (upon spray application). Various methods comprise mixing a first aqueous composition comprising a glufosinate component comprising L-glufosinate and/or a salt thereof with a second aqueous composition comprising an auxin herbicide component to form the tank mixture, wherein the L-glufosinate and/or salt thereof constitutes about 90 wt. % or more, about 95 wt. % or more, about 99 wt. % or more, or about 99.9 wt. % or more of the glufosinate component in the first aqueous composition, wherein the tank mixture upon spray application exhibits a spray particle size distribution having a reduced amount of particles that are less than 150 microns as compared to a similar tank mixture containing D,L-glufosinate.

The herbicidally effective amount of the herbicidal tank mixture to be applied is in part dependent upon various factors including the identity of the herbicides, the crop to be treated, and environmental conditions such as soil type and moisture content. However, the compositions and methods of the present disclosure provide for lower application rates of the glufosinate component. Accordingly, in various embodiments, the application rate of the glufosinate component is about 480 g/ha or less about, 400 g/ha or less, about 300 g/ha or less, or about 280 g/ha or less. In some embodiments, the application rate of the auxin herbicide component is about 300 g/ha or more, about 400 g/ha or more, about 450 g/ha or more, or about 480 g/ha or more. In certain embodiments, the application rate of the glufosinate component is from about 100 g/ha to about 480 g/ha, from about 200 g/ha to about 480 g/ha, from about 280 g/ha to about 480 g/ha, from about 100 g/ha to about 400 g/ha, from about 200 g/ha to about 400 g/ha, from about 280 g/ha to about 400 g/ha, from about 100 g/ha to about 300 g/ha, or from about 200 g/ha to about 300 g/ha and/or the application rate of the auxin herbicide component is from about 300 g/ha to about 600 g/ha, from about 400 g/ha to about 600 g/ha, from about 300 g/ha to about 500 g/ha, or from about 400 g/ha to about 500 g/ha.

The tank mixture may be applied to the unwanted plants according to practices known to those skilled in the art. In some embodiments, the herbicidal tank mixture is applied post-emergence to the unwanted plants.

In various embodiments, the tank mixture is used to control weeds in a field of crop plants. Commercially important crop plants include, for example, corn, soybean, cotton, dry beans, snap beans, and potatoes. Crop plants include hybrids, inbreds, and transgenic or genetically modified plants having specific traits or combinations of traits including, without limitation, herbicide tolerance (e.g., resistance to glyphosate, glufosinate, dicamba, sethoxydim, PPO inhibitor, etc.), Bacillus thuringiensis (Bt), high oil, high lysine, high starch, nutritional density, and drought resistance. In some embodiments, the crop plants are tolerant to organophosphorus herbicides, acetolactate synthase (ALS) or acetohydroxy acid synthase (AHAS) inhibitor herbicides, auxin herbicides and/or acetyl CoA carboxylase (ACCase) inhibitor herbicides. In some embodiments, the crop plants are tolerant to glufosinate, dicamba, 2,4-D, MCPA, quizalofop, glyphosate and/or diclofop-methyl. In other embodiments, the crop plant is glufosinate and/or dicamba tolerant. In some embodiments, crop plants are glyphosate and/or glufosinate tolerant. In other embodiments, the crop plants are glyphosate, glufosinate and dicamba tolerant. In these and other embodiments, the crop plants are tolerant to PPO inhibitors.

Herbicidal tank mixtures of the present disclosure are useful for controlling a wide variety of weeds, i.e., plants that are considered to be a nuisance or a competitor of commercially important crop plants. Examples of weeds that may be controlled according to methods of the present disclosure include, but are not limited to, Meadow Foxtail (Alopecurus pratensis) and other weed species with the Alopecurus genus, Common Barnyard Grass (Echinochloa crus-galli) and other weed species within the Echinochloa genus, crabgrasses within the genus Digitaria, White Clover (Trifolium repens), Lambsquarters (Chenopodium berlandieri), Redroot Pigweed (Amaranthus retroflexus) and other weed species within the Amaranthus genus, Common Purslane (Portulaca oleracea) and other weed species in the Portulaca genus, Chenopodium album and other Chenopodium spp., Setaria lutescens and other Setaria spp., Solanum nigrum and other Solanum spp., Lolium multiflorum and other Lolium spp., Brachiaria platyphylla and other Brachiaria spp., Sorghum halepense and other Sorghum spp., Conyza Canadensis and other Conyza spp., and Eleusine indica. In some embodiments, the weeds comprise one or more glyphosate-resistant species, 2,4-D-resistant species, dicamba-resistant species and/or ALS inhibitor herbicide-resistant species. In some embodiments, the glyphosate-resistant weed species is selected from the group consisting of Amaranthus palmeri, Amaranthus rudis, Ambrosia artemisiifolia, Ambrosia trifida, Conyza bonariensis, Conyza canadensis, Digitaria insularis, Echinochloa colona, Eleusine indica, Euphorbia heterophylla, Lolium multiflorum, Lolium rigidum, Plantago lancelata, Sorghum halepense, and Urochloa panicoides.

Various method described herein can further comprise mixing an additive such as a base and/or pH buffer with the tank mixture, first aqueous composition, and/or second aqueous composition.

Various methods described herein can further comprise mixing a monocarboxylic acid and/or salt thereof with the tank mixture, first aqueous composition, and/or second aqueous composition. Also, the first aqueous composition and/or second aqueous composition can further comprise a monocarboxylic acid and/or salt thereof. In various embodiments, the monocarboxylic acid and/or salt thereof is as described herein. For example, the monocarboxylic acid salt can have the formula R¹-C(O)OM, wherein R¹ is substituted or unsubstituted C₁-C₂₀ alkyl, substituted or unsubstituted C₂-C₂oalkenyl, substituted or unsubstituted aryl, and substituted or unsubstituted arylalkyl and M is an agriculturally acceptable cation. In some embodiments, the monocarboxylic acid and/or salt thereof comprises an acid selected from the group consisting of formic acid, acetic acid, propionic acid, benzoic acid, benzoic acid, mixtures thereof, and/or salts thereof. In certain embodiments, the monocarboxylic acid and/or salt thereof comprises acetic acid, sodium acetate, and/or potassium acetate.

The tank mixture as described herein can include any of the features as specified herein for the herbicidal composition.

Definitions

The term “hydrocarbyl” as used herein describes organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 30 carbon atoms.

The term “hydrocarbylene” as used herein describes radicals joined at two ends thereof to other radicals in an organic compound, and which consist exclusively of the elements carbon and hydrogen. These moieties include alkylene, alkenylene, alkynylene, and arylene moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 30 carbon atoms.

The term “substituted hydrocarbyl” as used herein describes hydrocarbyl moieties that are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, ketal, acyl, acyloxy, nitro, amino, amido, cyano, thiol, acetal, sulfoxide, ester, thioester, ether, thioether, hydroxyalkyl, urea, guanidine, amidine, phosphate, amine oxide, and quaternary ammonium salt.

The “substituted hydrocarbylene” moieties described herein are hydrocarbylene moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, ketal, acyl, acyloxy, nitro, amino, amido, cyano, thiol, acetal, sulfoxide, ester, thioester, ether, thioether, hydroxyalkyl, urea, guanidine, amidine, phosphate, amine oxide, and quaternary ammonium salt.

Unless otherwise indicated, the alkyl groups described herein are preferably lower alkyl containing from one to 18 carbon atoms in the principal chain and up to 30 carbon atoms. They may be straight or branched chain or cyclic and include methyl, ethyl, propyl, isopropyl, n-butyl, isobutyl, hexyl, 2-ethylhexyl, and the like.

Unless otherwise indicated, the alkenyl groups described herein are preferably lower alkenyl containing from two to 18 carbon atoms in the principal chain and up to 30 carbon atoms. They may be straight or branched chain or cyclic and include ethenyl, propenyl, isopropenyl, butenyl, isobutenyl, hexenyl, and the like. Unless otherwise indicated, the alkynyl groups described herein are preferably lower alkynyl containing from two to 18 carbon atoms in the principal chain and up to 30 carbon atoms. They may be straight or branched chain and include ethynyl, propynyl, butynyl, isobutynyl, hexynyl, and the like. The term “aryl” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl.

As used herein, the alkyl, alkenyl, alkynyl and aryl groups can be substituted with at least one atom other than carbon, including moieties in which a carbon chain atom is substituted with a hetero atom such as nitrogen, oxygen, silicon, phosphorous, boron, sulfur, or a halogen atom. These substituents include hydroxy, nitro, amino, amido, nitro, cyano, sulfoxide, thiol, thioester, thioether, ester and ether, or any other substituent which can increase the compatibility of the surfactant and/or its efficacy enhancement in the potassium glyphosate formulation without adversely affecting the storage stability of the formulation.

The terms “halogen” or “halo” as used herein alone or as part of another group refer to chlorine, bromine, fluorine, and iodine. Fluorine substituents are often preferred in surfactant compounds.

Unless otherwise indicated, the term “hydroxyalkyl” includes alkyl groups substituted with at least one hydroxy group, e.g., bis(hydroxyalkyl)alkyl, tris(hydroxyalkyl)alkyl and poly(hydroxyalkyl)alkyl groups. Preferred hydroxyalkyl groups include hydroxymethyl (—CH₂OH), and hydroxyethyl (—C₂H₄OH), bis(hydroxy-methyl)methyl (—CH(CH₂OH)₂), and tris(hydroxymethyl)methyl (—C(CH₂OH)₃).

The term “cyclic” as used herein alone or as part of another group denotes a group having at least one closed ring, and includes alicyclic, aromatic (arene) and heterocyclic groups.

The terms “heterocyclo” or “heterocyclic” as used herein alone or as part of another group denote optionally substituted, fully saturated or unsaturated, monocyclic or bicyclic, aromatic or nonaromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heterocyclo include heteroaromatics such as furyl, thienyl, pyridyl, oxazolyl, pyrrolyl, indolyl, quinolinyl, or isoquinolinyl and the like, and non-aromatic heterocyclics such as tetrahydrofuryl, tetrahydrothienyl, piperidinyl, pyrrolidino, etc. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, thioester, thioether, ketal, acetal, ester and ether.

The term “heteroaromatic” as used herein alone or as part of another group denote optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heteroaromatics include furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, thioether, thioester, ketal, acetal, ester and ether.

The term “acyl,” as used herein alone or as part of another group, denotes the moiety formed by removal of the hydroxyl group from the group —COOH of an organic carboxylic acid, e.g., RC(O)—, wherein R is R¹, R¹O—-, R¹R²N—, or R¹S—, R¹ is hydrocarbyl, heterosubstituted hydrocarbyl, or heterocyclo and R² is hydrogen, hydrocarbyl or substituted hydrocarbyl.

The term “acyloxy,” as used herein alone or as part of another group, denotes an acyl group as described above bonded through an oxygen linkage (—O—), e.g., RC(O)O— wherein R is as defined in connection with the term “acyl.”

When a maximum or minimum “average number” is recited herein with reference to a structural feature such as oxyethylene units, it will be understood by those skilled in the art that the integer number of such units in individual molecules in a surfactant preparation typically varies over a range that can include integer numbers greater than the maximum or smaller than the minimum “average number”. The presence in a composition of individual surfactant molecules having an integer number of such units outside the stated range in “average number” does not remove the composition from the scope of the present disclosure, so long as the “average number” is within the stated range and other requirements are met.

### EXAMPLES

The following non-limiting examples are provided to further illustrate the present disclosure.

### Example 1: Preparation of Tank Mixtures

Table 1 presents tank mixtures in accordance with the present disclosure. Mixtures are made to achieve a spray volume of 15 gal per acre (A).

TABLE 1

| Comp. | |
|---|---|
| No. | Ingredient |
| 1 | 16 oz/A 280 g a.e./L ammonium salt of L-glufosinate |
| | formulation + 22 oz/A XTENDIMAX (350 g a.e./L |
| | diglycolamine salt of dicamba) |
| 2 | 16 oz/A 280 g a.e./L ammonium salt of L-glufosinate |
| | formulation + 12.8 oz/A ENGENIA (600 g a.e./L |
| | N,N-bis-(3-aminopropyl) methylamine salt of dicamba) |
| 3 | 16 oz/A 280 g/L ammonium salt of L-glufosinate |
| | formulation + 16 oz/A CLARITY (480 g a.e./L |
| | diglycolamine salt of dicamba) |

### Example 2: Efficacy Testing

Weed control of the tank mixes described in Example 1 is tested and compared to the formulations presented in Table 2.

TABLE 2

| Comp. | |
|---|---|
| No. | Ingredient |
| 4 | 32 oz/A LIBERTY (ammonium salt of D,L-glufosinate) |
| 5 | 22 oz/A XTENDIMAX (350 g a.e./L diglycolamine salt |
| | of dicamba) |
| 6 | 12.8 oz/A ENGENIA (600 g a.e./L N,N-bis-(3-aminopropyl) |
| | methylamine salt of dicamba) |
| 7 | 16 oz/A CLARITY (480 g a.e./L diglycolamine salt of dicamba) |
| 8 | 16 oz/A 280 g/L L-glufosinate formulation |
| 9 | 32 oz/A LIBERTY (ammonium salt of D,L-glufosinate) + |
| | 22 oz/A XTENDIMAX (350 g a.e./L diglycolamine salt |
| | of dicamba) |
| 10 | 32 oz/A LIBERTY (ammonium salt of D,L-glufosinate) + |
| | 12.8 oz/A ENGENIA (600 g a.e./L N,N-bis-(3-aminopropyl) |
| | methylamine salt of dicamba) |
| 11 | 32 oz/A LIBERTY (ammonium salt of D,L-glufosinate) + |
| | 16 oz/A CLARITY (480 g a.e./L diglycolamine salt of dicamba) |

### Example 3: Humidome Volatility

Volatility of an auxin herbicide from an application mixture (e.g., tank mix) is measured in accordance with the procedure described in “A Method to Determine the Relative Volatility of Auxin Herbicide Formulations” in ASTM publication STP1587 entitled “Pesticide Formulation and Delivery Systems: 35th Volume, Pesticide Formulations, Adjuvants, and Spray Characterization in 2014,” published 2016, which is incorporated herein by reference. The general procedure is described briefly below.

Humidomes obtained from Hummert International (Part Nos 14-3850-2 for humidomes and 11-3050-1 for 1020 flat tray) are modified by cutting a 2.2 cm diameter hole on one end approximately 5 cm from the top to allow for insertion of a glass air sampling tube (22 mm OD) containing a polyurethane foam (PUF) filter. The sampling tube is secured with a VITON o-ring on each side of the humidome wall. The air sampling tube external to the humidome is fitted with tubing that was connected to a vacuum manifold immediately prior to sampling.

The flat tray beneath the humidome is filled with 1 liter of sifted dry or wet 50/50 soil (50% Redi-Earth and 50% US 10 Field Soil) to a depth of about 1 cm. Spray solutions of each formulation are prepared to contain 1.2% a.e. of total auxin herbicide, which is equivalent to an application rate of 1.0 lb/A a.e. at 10 gallons per acre (GPA), and then sprayed onto the soil of each humidome. Four separate humidome boxes are sprayed to have four replicate measurements for each formulation.

The flat tray bottom containing the application mixture on soil is covered with the humidome lid and the lid was secured with clamps. The growth chambers are set at 35° C. and 40% relative humidity (RH). The assembled humidomes are placed in a temperature and humidity controlled environment and connected to a vacuum manifold through the air sampling line. Air is drawn through the humidome and PUF at a rate of 2 liters per minute (LPM) for 24 hours at which point the air sampling is stopped. The humidomes are then removed from the controlled environment and the PUF filter was removed. The PUF filter is extracted with 20 mL of methanol and the solution is analyzed for the auxin herbicide concentration using LC-MS methods known in the art.

### Example 4: Spray Particle Size Evaluation

The spray particle size distributions of tank mixtures presented in Example 1 are measured by light scattering. This technique passes a visible laser through the droplets and measures scattering, from which the distribution of droplet sizes in the spray can be determined. The measurement is performed by mounting the nozzle on a track and traversing the nozzle during the measurement so that the entire spray pattern is sampled nine times during each measurement. The spray is directed into a tray from which it was recirculated to the nozzle. No wind tunnel is used. The particle size distribution is measured with a Malvern SPRAYTEC which uses a He-Ne laser. The Malvern software integrates and weights the data to provide an overall particle size distribution for the complete spray fan and calculates the “derived parameters” which characterize the spray. The key derived parameters are the volume-weighted mean droplet diameter (Dv50) and the fraction of driftable fine particles. Several definitions of driftable fines are used. Driftable fines are quantified as the volume percent of the spray with a diameter less than 150 p.m.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

In view of the above, it will be seen that the several objects of the present disclosure are achieved and other advantageous results attained.

As various changes could be made in the above compositions and methods without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

What is claimed is:

1. An aqueous herbicidal composition comprising:
a glufosinate component comprising L-glufosinate and/or a salt thereof, wherein the L-glufosinate and/or salt thereof constitutes about 90 wt. % or more of the glufosinate component;
an auxin herbicide component; and
water,
wherein the molar ratio of the auxin herbicide component to the glufosinate component on an acid equivalent basis is about 1:1, or greater, and
wherein the total herbicide concentration of the composition on an acid equivalent basis is about 5 wt. % or less.

2. The composition of claim 1, wherein the total herbicide concentration of the composition on an acid equivalent basis is from about 0.1 wt. % to about 5 wt. %.

3. The composition of claim 1, wherein the glufosinate component comprises a salt of L-glufosinate.

4. The composition of claim 1, wherein the glufosinate component comprises the ammonium salt of L-glufosinate.

5. The composition of claim 1, wherein the concentration of the glufosinate component on an acid equivalence basis is about 2 wt. % or less.

6. (canceled)

7. The composition of claim 1, wherein the auxin herbicide component comprises at least one auxin herbicide selected from the group consisting of dicamba (3,6-dichloro-2-methoxy benzoic acid); 2,4-D (2,4-dichlorophenoxyacetic acid); 2,4-DB (4-(2,4-dichlorophenoxy)butanoic acid); dichloroprop (2-(2,4-dichlorophenoxy)propanoic acid); MCPA ((4-chloro-2-methylphenoxy)acetic acid); MCPB (4-(4-chloro-2-methylphenoxy)butanoic acid); aminopyralid (4-amino-3,6-dichloro-2-pyridinecarboxylic acid); fluoroxpyr ([(4-amino-3,5-dichloro-6-fluoro-2-pyridinyl)oxy] acetic acid); triclopyr ([(3,5,6-trichloro-2-pyridinyl)oxy] acetic acid); diclopyr; mecoprop ((2-(4-chloro-2-methylphenoxy)propanoic acid); mecoprop-P; picloram (4-amino-3,5,6-trichloro-2-pyridinecarboxylic acid); quinclorac (3,7-dichloro-8-quinolinecarboxylic acid);
aminocyclopyrachlor (6-amino-5-chloro-2-cyclopropyl-4-pyrimidinecarboxylic acid); benazolin;
halauxifen; fluorpyrauxifen; methyl 4-amino-3-chloro-5-fluoro-6-(7-fluoro-1H-indo1-6-yl)pyridine-2-carboxylate; 4-amino-3-chloro-5-fluoro-6-(7-fluoro-1H-indo1-6-yl)pyridine-2-carboxylic acid; benzyl 4-amino-3-chloro-5-fluoro-6-(7-fluoro-1H-indo1-6-yl)pyridine-2-carboxylate; methyl 4-amino-3-chloro-5-fluoro-6-(7-fluoro-l-isobutyryl-1H-indo1-6-yl)pyridine-2-carboxylate; methyl 4-amino-3-chloro-6-[1-(2,2-dimethylpropanoyl)-7-fluoro-1H-indol-6-yl]-5-fluoropyridine-2-carboxylate; methyl 4-amino-3-chloro-5-fluoro-6-[7-fluoro-1-(methoxyacetyl)-1H-indo1-6-yl]pyridine-2-carboxylate; methyl 6-(1-acetyl-7-fluoro-1H-indo1-6-yl)-4-amino-3-chloro-5-fluoropyridine-2-carboxylate; potassium 4-amino-3-chloro-5-fluoro-6-(7-fluoro-1H-indo1-6-yl)pyridine-2-carboxylate; and butyl 4-amino-3-chloro-5-fluoro-6-(7-fluoro-1H-indo1-6-yl)pyridine-2-carboxylate; including salts and esters thereof, racemic mixtures and resolved isomers thereof; and combinations thereof.

8. The composition of claim 1, wherein the auxin herbicide component comprises dicamba and/or a salt thereof; and
wherein the salt of dicamba is selected from the group consisting of the monoethanolamine salt, tetrabutylamine salt, dimethylamine salt, isopropylamine salt, diglycolamine salt, N,N-bis-(3-aminopropyl)methylamine salt, potassium salt, sodium salt, and combinations thereof.

9.-12. (canceled)

13. The composition of claim 1, wherein the concentration of the auxin herbicide component on an acid equivalence basis is at least about 0.1 wt. % or more. and/or
wherein the molar ratio of the auxin herbicide component to the glufosinate component on an acid equivalent basis is from about 1:1 to about 4:1.

14.-15. (canceled)

16. The composition of claim 1, wherein the composition further comprises a monocarboxylic acid and/or salt thereof;
wherein the monocarboxylic acid salt has the formula R¹-C(O)OM; and
wherein R¹ is substituted or unsubstituted C₁-C₂₀ alkyl, substituted or unsubstituted C₂-C₂₀ alkenyl, substituted or unsubstituted aryl, and substituted or unsubstituted arylalkyl and M is an agriculturally acceptable cation.

17. (canceled)

18. The composition of claim 16, wherein the monocarboxylic acid and/or salt thereof comprises an acid selected from the group consisting of formic acid, acetic acid, propionic acid, benzoic acid, benzoic acid, mixtures thereof, and/or salts thereof.

19. (canceled)

20. The composition of claim 16, wherein the concentration of the monocarboxylic acid and/or salt thereof is at least about 0.01 wt. % or more. and/or
wherein the acid equivalent molar ratio of the monocarboxylic acid and/or salt thereof to the auxin herbicide component is at least about 10:1.

21.-23. (canceled)

24. The composition of claim 1, wherein the composition further comprises a surfactant component.

25. The composition of claim 24, wherein the concentration of the surfactant component is about 0.2 wt. % or less.

26. (canceled)

27. The composition of claim 24, wherein the surfactant component comprises at least one surfactant selected from the group consisting of alkyl sulfates, alkyl ether sulfates, alkyl aryl ether sulfates, alkyl sulfonates, alkyl ether sulfonates, alkyl aryl ether sulfonates, alkylpolysaccharides, amidoalkylamines, alkoxylated alcohols, alkoxylated alkylamines, alkoxylated phosphate esters, and combinations thereof.

28.-30. (canceled)

31. A method of controlling the growth of unwanted plants, the method comprising:
applying to the unwanted plants an herbicidally effective amount of a tank mixture comprising the composition of claim 1.

32. (canceled)

33. A method of controlling the growth of unwanted plants, the method comprising:
mixing a first aqueous composition comprising a glufosinate component comprising L-glufosinate and/or a salt thereof with a second aqueous composition comprising an auxin herbicide component to form a tank mixture, wherein the L-glufosinate and/or salt thereof constitutes about 90 wt. % or more of the glufosinate component in the first aqueous composition; and
applying the tank mixture to the unwanted plants,
wherein the application rate of the glufosinate component is about 480 g/ha or less and the application rate of the auxin herbicide component is about 300 g/ha or more.

34. A method of reducing auxin herbicide off-target movement upon application of a tank mixture to unwanted plants, the method comprising:
preparing a first aqueous composition comprising a glufosinate component comprising L-glufosinate and/or a salt thereof, wherein the L-glufosinate and/or salt thereof constitutes about 90 wt. % or more of the glufosinate component;
preparing a second aqueous composition comprising an auxin herbicide component;
mixing the first aqueous composition and second aqueous composition to form the tank mixture; and
applying the tank mixture to the unwanted plants,
wherein the application rate of the glufosinate component is about 480 g/ha or less and the application rate of the auxin herbicide component is about 300 g/ha or more; and
wherein the auxin herbicide off-target movement upon application is reduced as compared to a similar tank mixture containing D,L-glufosinate.

35. A method of reducing the volatility of a tank mixture comprising an auxin herbicide component, the method comprising:
mixing a first aqueous composition comprising a glufosinate component comprising L-glufosinate and/or a salt thereof with a second aqueous composition comprising an auxin herbicide component to form the tank mixture, wherein the L-glufosinate and/or salt thereof constitutes about 90 wt. % or more of the glufosinate component in the first aqueous composition,
wherein the tank mixture exhibits a reduced auxin herbicide volatility as compared to a similar tank mixture containing D,L-glufosinate.

36. A method of reducing driftable spray fines of a tank mixture comprising an auxin herbicide component, the method comprising:
mixing a first aqueous composition comprising a glufosinate component comprising L-glufosinate and/or a salt thereof with a second aqueous composition comprising an auxin herbicide component to form the tank mixture, wherein the L-glufosinate and/or salt thereof constitutes about 90 wt. % or more of the glufosinate component in the first aqueous composition,
wherein the tank mixture upon spray application exhibits a spray particle size distribution having a reduced amount of particles that are less than 150 microns as compared to a similar tank mixture containing D,L-glufosinate.

37.-40. (canceled)

41. The method of claim 31, wherein the molar ratio of the auxin herbicide component to the glufosinate component on an acid equivalent basis is about 1.1:1 or greater.

42. (canceled)

43. The method of claim 31, wherein the total herbicide concentration of the tank mixture on an acid equivalent basis is about 5 wt. % or less.

44. (canceled)

45. The method of claim 31, wherein the glufosinate component comprises a salt of L-glufosinate.

46. The method of claim 31, wherein the glufosinate component comprises the ammonium salt of L-glufosinate.

47. The method of claim 31, wherein the concentration of the glufosinate component on an acid equivalence basis in the tank mixture is about 2 wt. % or less.

48. (canceled)

49. The method of claim 31, wherein the auxin herbicide component comprises at least one auxin herbicide selected from the group consisting of dicamba (3,6-dichloro-2-methoxy benzoic acid); 2,4-D (2,4-dichlorophenoxyacetic acid); 2,4-DB (4-(2,4-dichlorophenoxy)butanoic acid); dichloroprop (2-(2,4-dichlorophenoxy)propanoic acid); MCPA ((4-chloro-2-methylphenoxy)acetic acid); MCPB (4-(4-chloro-2-methylphenoxy)butanoic acid); aminopyralid (4-amino-3,6-dichloro-2-pyridinecarboxylic acid); fluoroxpyr ([(4-amino-3,5-dichloro-6-fluoro-2-pyridinyl)oxy] acetic acid); triclopyr ([(3,5,6-trichloro-2-pyridinyl)oxy] acetic acid); diclopyr; mecoprop ((2-(4-chloro-2-methylphenoxy)propanoic acid); mecoprop-P; picloram (4-amino-3,5,6-trichloro-2-pyridinecarboxylic acid); quinclorac (3,7-dichloro-8-quinolinecarboxylic acid);
aminocyclopyrachlor (6-amino-5-chloro-2-cyclopropyl-4-pyrimidinecarboxylic acid); benazolin;
halauxifen; fluorpyrauxifen; methyl 4-amino-3-chloro-5-fluoro-6-(7-fluoro-1H-indo1-6-yl)pyridine-2-carboxylate; 4-amino-3-chloro-5-fluoro-6-(7-fluoro-1H-indo1-6-yl)pyridine-2-carboxylic acid; benzyl 4-amino-3-chloro-5-fluoro-6-(7-fluoro-1H-indo1-6-yl)pyridine-2-carboxylate; methyl 4-amino-3-chloro-5-fluoro-6-(7-fluoro-l-isobutyryl-1H-indo1-6-yl)pyridine-2-carboxylate; methyl 4-amino-3-chloro-6-[1-(2,2-dimethylpropanoyl)-7-fluoro-1H-indo1-6-yl]-5-fluoropyridine-2-carboxylate; methyl 4-amino-3-chloro-5-fluoro-6-[7-fluoro-1-(methoxyacetyl)-1H-indo1-6-yl]pyridine-2-carboxylate; methyl 6-(1-acetyl-7-fluoro-1H-indo1-6-yl)4-amino-3-chloro-5-fluoropyridine-2-carboxylate; potassium 4-amino-3-chloro-5-fluoro-6-(7-fluoro-1H-indo1-6-yl)pyridine-2-carboxylate; and butyl 4-amino-3-chloro-5-fluoro-6-(7-fluoro-1H-indo1-6-yl)pyridine-2-carboxylate; including salts and esters thereof, racemic mixtures and resolved isomers thereof; and combinations thereof.

50. The method of claim 31, wherein the auxin herbicide component comprises dicamba and/or a salt thereof; and
wherein the salt of dicamba is selected from the group consisting of the monoethanolamine salt, tetrabutylamine salt, dimethylamine salt, isopropylamine salt, diglycolamine salt, N,N-bis-(3-aminopropyl)methylamine salt, potassium salt, sodium salt, and combinations thereof.

51.-53. (canceled)

54. The method of claim 31, wherein the concentration of the auxin herbicide component on an acid equivalence basis in the tank mixture is at least about 0.1 wt. % or more.

55. (canceled)

56. The method of claim 31, wherein the tank mixture further comprises:
an additional herbicide such as an acetyl CoA carboxylase (ACCase) inhibitors, enolpyruvyl shikimate-3-phosphate synthase (EPSPS) inhibitors, photosystem I (PS I) inhibitors, photosystem II (PS II) inhibitors, acetolactate synthase (ALS) or acetohydroxy acid synthase (AHAS) inhibitors, mitosis inhibitors, protoporphyrinogen oxidase (PPO) inhibitors, hydroxyphenylpyruvate dioxygenase (HPPD) inhibitors, cellulose inhibitors, oxidative phosphorylation uncouplers, dihydropteroate synthase inhibitors, fatty acid and lipid biosynthesis inhibitors, auxin transport inhibitors, salts and esters thereof, racemic mixtures and resolved isomers thereof, and mixtures thereof; and/or
(ii) a surfactant component.

57. (canceled)

58. The method of claim 56, wherein the concentration of the surfactant component in the tank mixture is about 0.2 wt. % or less.

59. (canceled)

60. The method of claim 56, wherein the surfactant component comprises at least one surfactant selected from the group consisting of alkyl sulfates, alkyl ether sulfates, alkyl aryl ether sulfates, alkyl sulfonates, alkyl ether sulfonates, alkyl aryl ether sulfonates, alkylpolysaccharides, amidoalkylamines, alkoxylated alcohols, alkoxylated alkylamines, alkoxylated phosphate esters, and combinations thereof.

61.-63. (canceled)

64. The method of claim 31, further comprising mixing a monocarboxylic acid and/or salt thereof with the tank mixture, first aqueous composition, and/or second aqueous compositions;
wherein the monocarboxylic acid salt has the formula R¹—C(O)OM; and
wherein R¹ is substituted or unsubstituted C₁-C₂₀ alkyl, substituted or unsubstituted C₂-C₂₀ alkenyl, substituted or unsubstituted aryl, and substituted or unsubstituted arylalkyl and M is an agriculturally acceptable cation.

65.-66. (canceled)

67. The method of any one of claim 64, wherein the monocarboxylic acid and/or salt thereof comprises an acid selected from the group consisting of formic acid, acetic acid, propionic acid, benzoic acid, benzoic acid, mixtures thereof, and/or salts thereof.

68. (canceled)

69. The method of claim 64, wherein the concentration of the monocarboxylic acid and/or salt thereof is at least about 0.01 wt. % or more.

70. (canceled)
